(19) United States
(12) Patent Application Publication
(10) Pub. No.: US 2026/0205144 A1
(43) Pub. Date: Jul. 16, 2026

(54) ACTIVE PASSIVE ANTENNA SYSTEM

(71) Applicant: T-MOBILE INNOVATIONS LLC, Overland Park, KS (US)

(72) Inventor: Chaitanya CHUKKA, Plainfield, IL (US)

(21) Appl. No.: 19/017,053

(22) Filed: Jan. 10, 2025

(51) Int. Cl. H04B 1/00

(52) U.S. Cl. CPC H04B 1/0053

(57) ABSTRACT

The present disclosure relates to an active-passive antenna system for wireless telecommunication networks. The system integrates active and passive antenna elements into a single unit, with the active portion capable of selecting between different frequency bands and adjusting transmission power to mitigate thermal noise. Advanced components enable dynamic beamforming and MIMO functionality, while the passive portion provides consistent coverage at lower frequencies. The unitary radome design simplifies installation, reduces tower lease costs, and improves aesthetic integration. Computer processing components determine trigger events and modify the active portion's transmission profile, ensuring optimal performance and reliable connectivity across various deployment scenarios.

### SUMMARY

The present disclosure is directed to a combined active passive antenna system, substantially as shown and/or described in connection with at least one of the Figures, and as set forth more completely in the claims.

The present disclosure is directed to an active-passive antenna system designed to enhance wireless telecommunication networks by integrating active and passive antenna elements into a single unit. A key feature of this invention is the trigger-based modification of the transmission profile. In response to detecting a trigger condition, such as mechanical downtilting or thermal noise, the active passive system may modify a transmission profile by selecting different frequency bands or adjusting transmission power to ensure optimal performance. By dynamically adjusting frequencies and power levels, the system ensures reliable connectivity for user equipment even at the edges of coverage areas. In aspects, the active passive antenna system uses a unitary radome design, that may feature an inter-chamber divider, which can simplify installation and maintenance, reduce tower lease costs, and improve aesthetic integration. The active portion includes advanced components such as amplifiers and signal processing units, enabling dynamic beamforming and MIMO functionality for high-frequency, high-capacity data transmission. The passive portion provides consistent coverage at lower frequencies. This integrated approach supports various deployment scenarios, including cellular and Wi-Fi networks, making it adaptable and efficient for modern telecommunication needs.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts a computing device suitable for use with implementations of the present disclosure;

FIG. 2 illustrates a representative network environment for use with implementations of the present disclosure;

FIG. 3 illustrates a base station for use with implementing aspects of the present disclosure;

FIG. 4 illustrates an active passive antenna system according to aspects of the present disclosure; and

FIG. 5 depicts a flow diagram of a method for use with the aspects of the disclosure described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32^{nd} Edition, 2022). As used herein, the terms “base station” or “access point” refer to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies suitable for use with the present disclosure include but are not limited to 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, wireless telecommunication networks have evolved significantly over the past few decades, driven by the increasing demand for high-speed data and reliable connectivity. These networks rely on a complex infrastructure of antennas and base stations to provide coverage and capacity to users. Traditionally, separate antenna systems have been employed to handle different frequency bands, with lower frequencies used for broad coverage and higher frequencies for high-capacity data transmission. This approach, while effective, presents several challenges.

In the context of cellular networks, the deployment of multiple antenna systems on a single tower can lead to increased costs and logistical issues. Tower owners often charge double the lease for hosting separate systems, and the physical space on towers is limited, necessitating a reduction in the number of antenna panels. Furthermore, integrating these systems into a single unit introduces technical difficulties. When active and passive antenna systems are combined, they must be manually tilted together, which can generate heat and cause interference. The heat from the passive system can distort the signaling of the active system, particularly at higher frequencies, compromising its ability to provide adequate capacity to the intended coverage area.

Unlike conventional solutions, the present disclosure is directed to active-passive antenna systems and methods for using them. This innovative system integrates active and passive antenna elements into a single unit, optimizing both coverage and capacity in wireless telecommunication networks. The active portion is capable of selecting between different frequency bands to overcome the challenges of mechanical downtilting, ensuring that high-frequency signals maintain their intended coverage area. Additionally, the active portion can adjust transmission power to mitigate thermal noise generated by the passive portion, enhancing overall signal quality. Structurally, the system may feature a unitary radome that houses both active and passive elements, potentially separated by an inter-chamber divider to manage interference and thermal effects. This design not only simplifies installation and maintenance but also reduces tower lease costs and improves aesthetic integration. By dynamically adjusting frequencies and power levels, the invention ensures optimal performance across various deployment scenarios, including cellular and Wi-Fi networks, while maintaining reliable connectivity for user equipment.

Accordingly, a first aspect of the present disclosure is directed to an active passive antenna system. The system an antenna assembly configured to transmit wireless signals to a coverage area, the antenna assembly comprising an active portion and a passive portion, each of the active portion and the passive portion comprising a plurality of antenna elements. The system further comprises one or more computer processing components configured to perform operations. The operations comprise determining that a trigger event has occurred. The operations further comprise, in response to said determination, modifying a transmission profile used by the active portion to transmit a first set of downlink signals.

Another aspect of the present disclosure is directed to a method for operating an active passive antenna system. The method comprises transmitting a first set of downlink signals from an active portion of an antenna assembly using a first active transmission profile to a first coverage area. The method further comprises transmitting a second set of downlink signals from a passive portion of the antenna assembly using a passive transmission profile to a second coverage area. The method further comprises determining that a trigger event has occurred. The method further comprises in response to said determination, transmitting the first set of downlink signals from the active portion of the antenna assembly using a second active transmission profile, the second active transmission profile being different than the first active transmission profile.

Another aspect of the present disclosure is directed to non-transitory computer readable media having computer-executable instructions stored thereon that, when executed by one or more computer processor components, cause the one or more computer processing components to perform operations for operating an active passive antenna system. The operations comprise transmitting a first set of downlink signals from an active portion of an antenna assembly using a first active transmission profile to a first coverage area. The operations further comprise transmitting a second set of downlink signals from a passive portion of the antenna assembly using a passive transmission profile to a second coverage area. The operations further comprise determining that a trigger event has occurred. The operations further comprise in response to said determination, transmitting the first set of downlink signals from the active portion of the antenna assembly using a second active transmission profile, the second active transmission profile being different than the first active transmission profile.

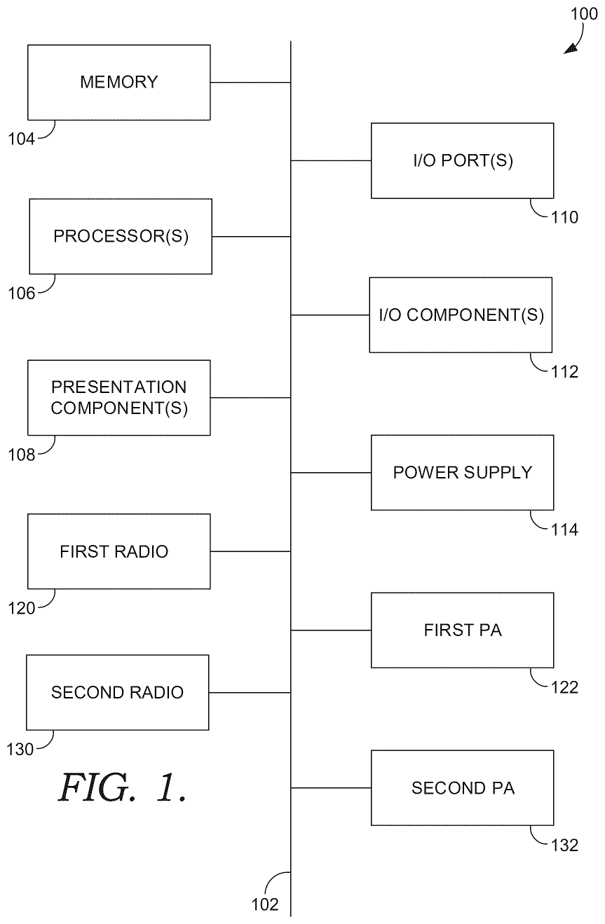

Referring to FIG. 1, a representative computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) devices (e.g., virtual reality, augmented reality, or mixed reality devices), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of one example of a computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. The memory 104 may take the form of solid-state memory, hard drives, optical-disc drives, etc. Computing device 100 includes one or more processors 106 that read data from various entities such as bus 102, memory 104 or I/O components 112. One or more presentation components 108 presents data indications to a person or other device. The one or more presentation components 108 may comprise one or more of a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may be configured to communicate with one or more other computing devices according to a local area communication protocol (e.g., IEEE 802.11 series, Bluetooth, NFC, z-wave, or the like).

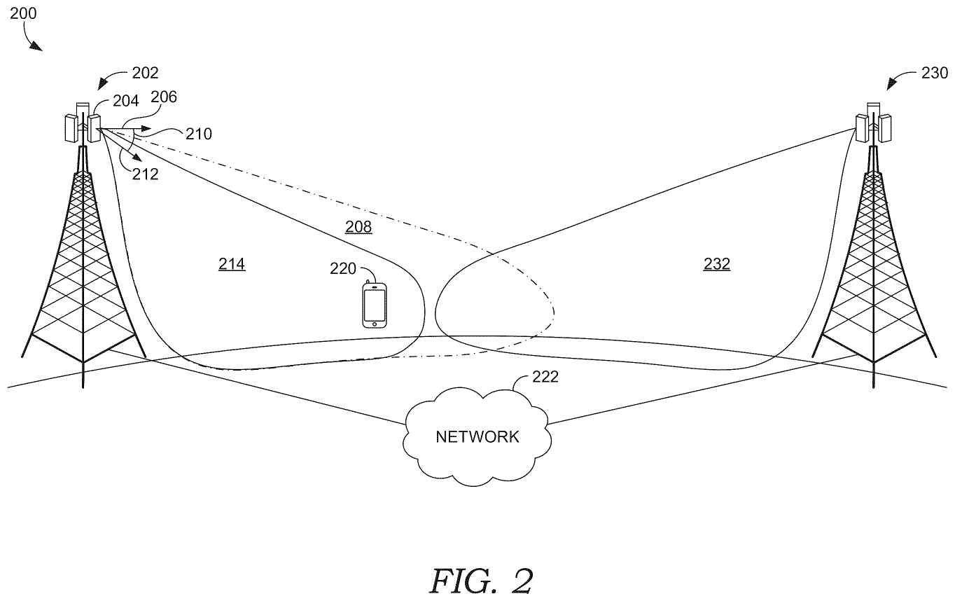

Turning now to FIG. 2, a representative network environment is illustrated in which implementations of the present disclosure may be employed. Such a network environment is designated generally as network environment 200. At a high level, the network environment 200 comprises one or more user equipment (UEs), one or more base stations, and one or more networks. Specifically, the network environment 200 includes a first base station 202, a second base station 230, a user equipment (UE) 220, and a network 222. While the UE 220 is illustrated as a representative user device, such as a cellular phone, it should be understood that a UE suitable for implementations of the present disclosure may include any computing device with wireless communication capabilities. Similarly, though the base stations 202 and 230 are illustrated as macro cells on cellular towers, the present disclosure contemplates any scale or form of access point capable of wireless communication with a UE, including small cells, pico cells, and the like. Although illustrated as a cellular macro base station, a suitable base station for implementations of the present disclosure may operate on essentially any protocol used by an access point, including but not limited to Wi-Fi, Bluetooth, Zigbee, or other wireless communication technologies.

The first base station 202 comprises hardware and software components that enable it to wirelessly communicate with the UE 220 in a designated coverage area. The first base station 202 includes an active-passive antenna system 204, capable of transmitting wireless signals to and receiving wireless signals from the UE 220. When the active-passive antenna system 204 is not tilted, it transmits along a first boresight 206, generating a relatively longer-distance first coverage area 208. In aspects of the present disclosure, the active-passive antenna system 204 may be mechanically downtilted by an angle 210, shifting the transmission boresight downward to a second boresight 212, in order to minimize the inter-cell interference which would have been created by overlapping with a coverage area 232 of the second base station 230. By mechanically tilting the antenna system, the first base station 202 reduces its coverage area from the first coverage area 208 to a relative shorter-distance second coverage area 214 while also avoiding the coverage area 232 and reducing/eliminating the inter-cell interference with the second base station 230.

The user equipment (UE) 220 is positioned within both the first coverage area 208 and the second coverage area 214. In the illustrated embodiment, the UE 220 is located near the edge of the second coverage area 214. Because signal strength typically diminishes at the edge of a coverage area, it is particularly important that signals transmitted by the first base station 202 via the active-passive antenna system 204 adequately reach the UE 220, ensuring continued connectivity and reliable performance. The first base station 202 transmits signals using one or more antenna elements of the active-passive antenna system 204, which may include hardware such as amplifiers, frequency-selective filters, and beamforming circuitry to optimize transmission.

The network 222 represents a mobile network operator network, such as a 5G core network, which facilitates communication and coordination between the base stations 202 and 230 and the user equipment 220. The network 222 provides connectivity, routing, and resource management for the first base station 202 and the second base station 230. It may further coordinate handovers, interference management, and other functions necessary for maintaining a high-quality user experience. It should be understood that the network environment 200 may include additional devices or components not explicitly shown, such as routers, core nodes, and gateways, which may form additional network environments similar to what is depicted in FIG. 2.

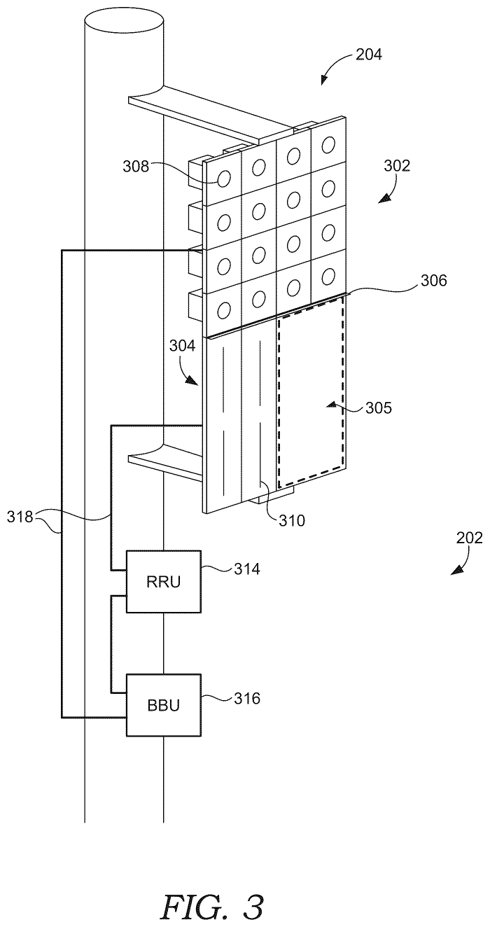

Turning now to FIG. 3, the first base station 202 of FIG. 2 is illustrated. The first base station 202 comprises the active passive antenna system 204 of FIG. 2. The active passive antenna system 204 includes an active portion 302 and a passive portion 304.

The active portion 302 integrates antenna elements with active components such as amplifiers, digital-to-analog converters (DACs), and signal processing units into a single compact unit, enabling advanced beamforming and multiple in, multiple out (MIMO) functionality. Unlike passive antenna systems, the active portion 302 directly processes and amplifies signals at the antenna level, providing precise control over phase and amplitude for each antenna element. This architecture enhances spectral efficiency, supports dynamic beam steering, and improves overall network performance, particularly in high-capacity deployments like 5G and Wi-Fi. The active portion 302 of the active passive antenna system 204 comprises a plurality of antenna elements 308 arranged in a configurable array, illustrated here as a single 4×4 MIMO array comprising 16 active antenna elements 308. In aspects, the active portion 302 may comprise a plurality of cross-polarized transmit antenna elements and receive antenna elements, but the active portion 302 may support various array sizes, geometries, and operational modes, including arrays larger or smaller than 4×4, single-element systems, or configurations without dedicated transmit and receive antenna elements (e.g., shared elements for both transmission and reception). The form and structure of the antenna elements may vary and include, for example, patch antennas, dipole antennas, or other suitable radiating elements optimized for specific operational requirements such as frequency band, beamwidth, or polarization. The system supports both contemporary designs, such as those found in modern 5G massive MIMO arrays, and alternative architectures suitable for legacy or specialized applications.

In addition to the hardware components, the active portion 302 operates under the control of sophisticated software algorithms. These algorithms manage the beamforming process, which involves dynamically adjusting the phase and amplitude of the signals transmitted and received by the antenna elements to optimize signal strength and coverage. The software also handles MIMO processing, enabling the system to transmit and receive multiple data streams simultaneously, thereby increasing data throughput and reliability.

The passive portion 304 comprises a plurality of passive antenna elements 310, each of which may take the form of a dipole antenna. These radiating elements are designed to enhance the system's overall coverage and signal strength. Though illustrated as dipoles, each of the plurality of passive antenna elements 310 may take any other suitable form, such as a monopole antenna, a loop antenna, or any other type of antenna that can effectively radiate electromagnetic waves. The combination of the active portion 302 and the passive portion 304, in aspects, may be desirable in deployments wherein an operator desires to have a fixed coverage area that provides a lower but more consistent level of coverage using the passive portion 304, and wherein the operator desires to have an at least partially overlapping second coverage area that provides a higher-throughput and more dynamic capacity layer using the active portion 302.

In aspects, the active portion 302 may comprise two or more sub-arrays that facilitate selecting and using one or more frequencies from a plurality of frequency options. Accordingly, the active portion 302 may comprise a first sub-array that is configured for a first set of frequencies (e.g., mid-band communications in the range of 1900 MHz-5 GHz) and a second sub-array that is configured for a second set of frequencies (e.g., high-band communications in the range of 24 GHz-30 GHz). In other aspects, the active portion may comprise a third sub-array that is configured for a third set of frequencies (e.g., a sub-array for mmWave frequencies in the range of 30 GHz-300 GHz). One skilled in the art will appreciate that different combinations of sub-arrays may be deployed on the active portion 302 based on the needs of an operator without departing from the present disclosure. In cellular deployments, the active portion 302 may be capable of communicating with UEs using two or more frequencies; whereas, the passive portion 304 is configured to communicate with UEs on a single frequency band. In other cellular deployments, the active portion 302 may be configured to communicate on a single frequency band and/or the passive portion 304 may be configured to communicate on two or more frequency bands. In Wi-Fi embodiments, each of the active portion 302 and the passive portion 304 may be configured to communicate using a single frequency band; for example, the passive portion 304 may utilize a first frequency band (e.g., 2.4 GHz band in the frequency range of 2.4 GHz-2.5 GHz) and the active portion 302 may utilize a second frequency band (e.g., 5 GHz band in the range of 5.15 GHz-5.85 GHz, 6 GHz frequency band in the range of 5.925 GHz-7.125 GHz, 7 GHz frequency band in the range of 7.125 GHz-8 GHz, and higher mmWave frequencies in the range of 42.5 GHz-71 GHz). Though discussed herein as unitary in terms of each deployment's wireless communication technologies, it is contemplated that the active passive antenna system 204 may take hybrid forms, wherein one portion (active or passive) may be used for one wireless communication technology (e.g., 4G, 5G, 6G, Wi-Fi, RFID, Bluetooth, NFC, and the like) and the other portion uses a second, different, wireless communication technology. Examples may include hybrid cellular/Wi-Fi systems, hybrid cellular/RFID systems, or hybrid Wi-Fi/RFID systems.

The active portion 302 and the passive portion 304 of the active passive antenna system 204 have distinct differences in their composition and functionality. The active portion 302 integrates active electronic components such as amplifiers, DACs, and ADCs directly into the antenna unit. This integration allows for advanced functionalities like beamforming and MIMO processing, which enhance signal quality and data throughput. In contrast, the passive portion 304 comprises passive radiating elements without integrated active electronics. These systems rely on external components, such as the RRU 314, to process signals. In aspects of the present disclosure, the active portion 302 is used for higher frequency bands than the passive portion 304; for example, the active portion may be configured to wirelessly communicate using mid-band frequencies around 2500 MHz or high-band frequencies like millimeter wave (mmWave), whereas the passive portion 304 may be configure to wirelessly communicate using lower frequency bands, such as those under 1000 MHz (e.g., 600 MHz), which provide better coverage and penetration through obstacles. One skilled in the art will appreciate that the particular pairing of frequency bands to the active portion 302 and the passive portion 304 may be tailored to the particular needs of a mobile network or RAN operator without departing from the present disclosure.

In some aspects, the active portion 302 and the passive portion 304 may use different radio access technologies (RATs). For example, the active portion 302 might use 5G technology, while the passive portion 304 might use 4G technology. This configuration allows for a combination of high-speed data transmission and extensive coverage. Although a single BBU 316 is illustrated in the figure, there may be more than one BBU to support different RATs and ensure optimal performance. In other aspects, different frequency bands using the same RAT may be used; for example, the passive portion 304 may use a 2.4 GHz Wi-Fi band and the active portion 302 may use a 5 GHz Wi-Fi band.

The active passive antenna system 204 may also include a void portion 305. This void portion 305 allows for further adaptation or the deployment of additional antenna systems, providing flexibility for future enhancements. The void portion 305 can be utilized to house additional components, such as filters, amplifiers, or other electronic devices that may be required for specific applications.

In aspects wherein antenna elements of the active passive antenna system 204 are not individually-enclosed (like how some Wi-Fi routers have individual antenna elements externally connected to a router), the plurality of antenna elements of the active passive antenna system 204 may be enclosed within a unitary radome or sub-arrays of the plurality of antenna elements may be within separate radomes, depending on deployment requirements. In some aspects, a unitary radome approach may be preferred due to the relative simplicity of installation and alignment, as the entire system can be mounted as a single unit, reducing mechanical complexity and potential misalignment issues. In the single radome embodiment, both the active portion 302 and the passive portion 304 (and the void portion 305, if present) are enclosed in a single radome and have a single (i.e., common) rear panel/backplane. The single radome approach may have a shared thermal management system, which can be leveraged for unified cooling or heat dissipation for both antenna portions, further enhancing system efficiency and reducing maintenance complexity. Further, a unitary radome approach may have non-technical benefits, such as incurring lower tower lease rates and improving perceived aesthetic from residents in an area surrounding its deployment. Alternatively, the first and second portions may be enclosed within separate radomes. The multi-radome approach allows for independent operation, modularity, and spatial separation of the two portions. Separate radomes may be particularly advantageous when physical separation is necessary to optimize performance, reduce interference, or accommodate different orientations or mounting requirements. They also enable independent replacement or maintenance of one portion without disturbing the other, offering greater operational flexibility.

In aspects wherein the active passive antenna system 204 features a unitary radome, it may be structured to compartmentalize the active portion 302 and the second portion 304 using an inter-chamber divider 306 disposed there between. The inter-chamber divider 306, if present, may take several forms depending on specific design requirements. For instance, the inter-chamber divider 306 could be constructed from metal (e.g., aluminum or copper) to act as a reflective surface, effectively creating a ground plane that enhances signal reflection and directivity for the lower portion. Alternatively, a Faraday mesh could be used, providing electromagnetic interference shielding while allowing for some degree of airflow or light passage, which might be beneficial for integrated thermal management. A dielectric material (e.g., high-performance ceramics or specialized composites) could also serve as the inter-chamber divider 306, offering radio frequency (RF) isolation while avoiding conductive interference with the signals. The choice of material depends on the operational frequencies, environmental considerations, and performance goals of the antenna system. In other aspects, the active passive antenna system 204 may comprise a single radome and may not comprise the inter-chamber divider 306.

The active portion 302 of the active passive antenna system 204 is connected to a Baseband Unit (BBU) 316 using a fronthaul link 318. This connection facilitates the transmission of data between the active antenna unit and the BBU. The fronthaul link 318 may be implemented using various technologies, such as fiber optic cables, microwave links, or any other suitable medium that can support high-speed data transmission. The BBU 316 is responsible for processing baseband signals and managing the overall operation of the antenna system. It includes various hardware components such as processors, memory, and interfaces for connecting to other network elements. The BBU 316 performs tasks such as signal modulation and demodulation, error correction, and protocol handling. It also runs software that manages network functions, including resource allocation, handover control, and interference management. Though illustrated and envisioned as a BBU, any computer processing component or set of computer processing components performing the activities described herein with respect to the BBU 316 may be used; for example, a base station controller or base station server in cellular networks or a central processing unit or system-on-a-chip in Wi-Fi access networks.

The passive portion 304 of the active passive antenna system 204 is connected to a Remote Radio Unit (RRU) 314 using a feeder cable(s) 312. The RRU 314 is a radio component that interfaces between the BBU 316 and the passive antenna elements 310, performing radio frequency (RF) functions such as frequency upconversion and downconversion, RF amplification, filtering, and signal conditioning. Unlike the active portion 302, which integrate these RF components directly with antenna elements for precise per-element control and advanced features like digital beamforming, the RRU 314 operates independently and connects to passive antennas via the feeder cable(s) 312. This separation of RF processing from the antenna allows for simpler antenna designs but lacks the granularity and flexibility of modern active antenna systems, which incorporate integrated DACs, amplifiers, and beamforming circuitry at each antenna element. The feeder cable 312 is responsible for carrying the radio frequency signals from the passive antenna unit to the RRU 314. The RRU 314 is then connected to the BBU 316 using another fronthaul link 318.

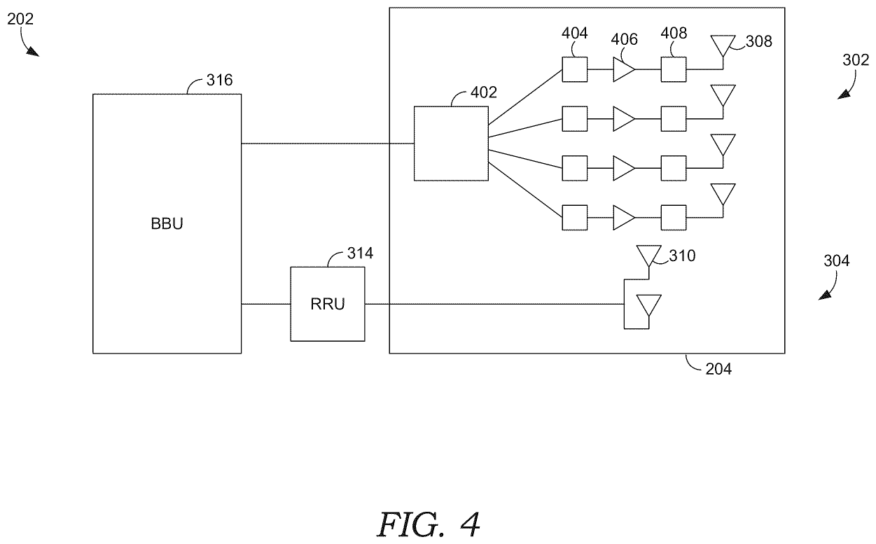

Turning now to FIG. 4, an alternative perspective of the base station 202 of FIGS. 2-3 is provided, which includes the active passive antenna system 204, the BBU 316, and the RRU 314 of FIG. 3. The active passive antenna system 204 comprises the active portion 302, illustrated as the top branch portion, and the passive portion 304, illustrated as the bottom branch portion. The portion of the active passive antenna system 204 that contains the active antenna elements 308 and the passive antenna elements 301 may be referred to as the antenna assembly, which may also include one or more components integrated into the active elements 308 (e.g., a DAC 404, an amplifier 406, or a frequency selective filter 408). In aspects wherein the BBU 316 output a combined (multiplexed) signal stream for multiple antenna branches, the active portion 302 comprises an active antenna module 402. The active antenna module 402 facilitates dynamic beamforming and spatial multiplexing by managing phase and amplitude adjustments across its integrated antenna arrays in real time. It serves as the interface between the BBU 316 and the radio frequency (RF) domain, enabling precise control of signal directionality and optimizing wireless coverage and capacity in advanced cellular networks. In aspects, the active antenna module 402 comprises a Digital Front End (DFE), which handles digital signal processing tasks, including beamforming and pre-distortion correction, and interfaces with the RF chain. The active antenna module may further comprise a local oscillator (LO), which generates reference signals necessary for frequency upconversion and downconversion, which are executed by a mixer to shift signals between baseband and RF frequencies. The active antenna module 402 may further comprise a clock distribution unit that ensures precise timing and synchronization among all components. The active antenna module 402 may further comprise one or more thermal management components, such as heat sinks or fans, to dissipate heat generated by active components like the power amplifiers 406.

The active passive antenna system 204 may comprise one or more computer processing components configured to control, monitor, and manage the transmissions from the active portion 302, collectively referred to herein as active antenna operations. In aspects, the one or more computer processing components may be incorporated into the active antenna module 402; in other aspects, said one or more computer processing components executing the active antenna operations may alternatively be disposed in the BBU 316 or any other suitable location of the base station 202. At a high level, the active antenna operations comprise detecting a trigger event and modifying a transmission profile of the active portion 302 of the active passive antenna system 204 without modifying the transmission profile of the passive portion 304 of the active passive antenna system 204. By modifying the transmission profile of the active portion 302 and not modifying the transmission profile of the passive portion 304, the active passive antenna system 204 can dynamically modify higher-capacity layers from the active portion 302 without compromising a static coverage layer provided by the passive portion 304. That is, the active portion 302 is configured to transmit downlink signals using dynamic radiation patterns; whereas, the passive portion 304 transmits downlink signals using a static/fixed radiation pattern. In a first embodiment, the trigger event may comprise detecting that the active passive antenna system 204 (or the antenna assembly) has been mechanically downtilted (i.e., that the boresight angle has decreased as discussed in FIG. 2) using a mechanical downtilting component. Based upon a determination that mechanical downtilting has occurred, the active antenna operations may comprise modifying a transmission profile of the active portion 302 by transmitting downlink signals on a second frequency band instead of a first frequency band, wherein the second frequency band has a lower center frequency than the first frequency band. In a second embodiment, the trigger event may comprise detecting that a threshold high number of connected UEs are located/clustered within a range of distances of the base station 202 and modifying the transmission profile of the active portion 302 to target the UEs. For example, if all (or nearly all) UEs are located closer to the base station, then the active antenna module will modify the transmission profile to use a higher frequency (fading being less of a factor); whereas, if all (or nearly all) of the UEs are located further from the base station, then the active antenna module will modify the transmission profile to use a lower frequency band that is more resistant to fading. In aspects of the first or second embodiment, the active antenna module 402 may modify transmission profiles by transmitting signals from different subarrays of the active portion 302; for example, a first subarray configured for UHF frequency bands may be used instead of a second subarray that is configured for mmWave frequency bands in order to provide for a coverage area that extends further from the base station. In a third embodiment, the active antenna module 402 the trigger event may comprise detecting high noise (e.g., thermal noise caused by the passive portion 304). In the third embodiment, the transmission profile may be modified by increasing the transmission power of the active portion, decreasing the power of the passive portion, modifying a thermal management system to reduce heat, deactivating one or more of the passive elements 310, or any combination thereof.

In addition to the active antenna module 402, the active portion 302 comprises a digital to analog converter (DAC) 404, an amplifier 406, a frequency selective filter 408, and the active antenna element 308 of FIG. 3. The DAC 404 is configured to convert digital baseband signals into analog RF signals for transmission, enabling precise signal generation and modulation for each antenna element in an active antenna system. Depending on the specific architecture, the DAC 404 may be implemented as a standalone component in digital systems, integrated with beamforming circuitry, or combined with other signal processing elements in hybrid or distributed active antenna configurations. The DAC 404 is connected to the amplifier 406. The amplifier 406 boosts the power of analog RF signals after conversion by the DAC, ensuring sufficient transmission power for each antenna element in the active antenna system. In different active antenna architectures, the amplifier 406 may be implemented as a dedicated power amplifier for each antenna element, integrated into a shared amplification module for multiple elements, or combined with adaptive circuitry to dynamically adjust power levels based on beamforming and coverage requirements. Each antenna branch of the active portion 302 comprises a frequency selective filter. Though illustrated in FIG. 4 as being located between the amplifier 406 and the active antenna element 308 of a particular antenna branch of the active portion 302, it is contemplated that the frequency selective filter 408 may be located between the DAC 404 and the amplifier 406, between the digital front end 402 and the DAC 404, or between the BBU 316 and the digital front end 402. The frequency selective filter 408 removes unwanted frequency components, such as harmonics and spurious emissions, while allowing the desired frequency band to pass through, ensuring spectral compliance and minimizing interference.

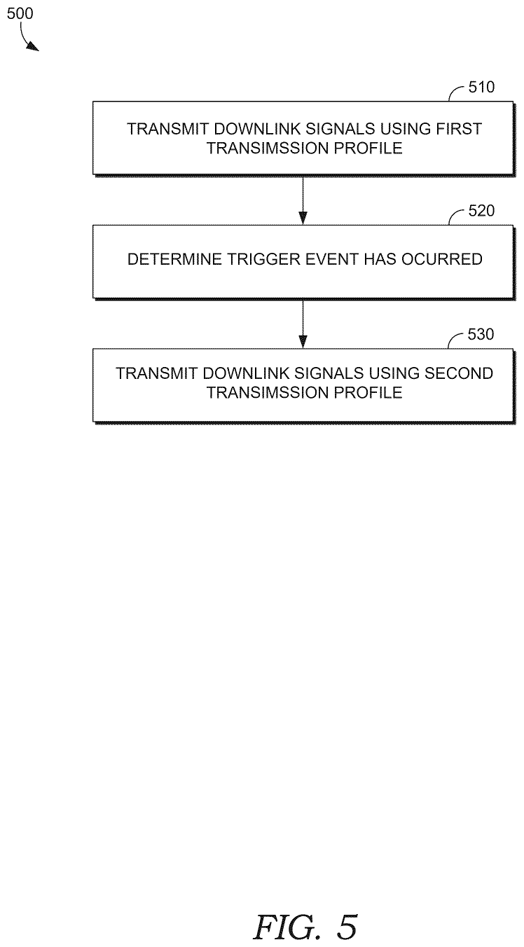

Turning now to FIG. 5, a flow chart representing a method 500 is provided. At a first step 510, a first set of downlink signals is transmitted from an active portion of an antenna assembly using a first active transmission profile and a second set of downlink signals is transmitted from a passive portion of the antenna assembly, according to any one or more aspects described above with respect to FIGS. 2-4. At a second step 520, it is determined that a trigger event has occurred, according to any one or more aspects described above with respect to FIGS. 2-4. At a third step 530, and in response to the second step 520, the first active transmission profile is modified and the first set of downlink signals are transmitted by the active portion using a second active transmission profile, without modifying the transmission profile used by the passive portion to transmit the second set of downlink signals, according to any one or more aspects described above with respect to FIGS. 2-4.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. An active passive antenna system comprising:
an antenna assembly configured to transmit wireless signals to a coverage area, the antenna assembly comprising an active portion and a passive portion, each of the active portion and the passive portion comprising a plurality of antenna elements; and
one or more computer processing components communicatively coupled to configured to perform operations comprising:
determining that a trigger event has occurred; and
in response to said determination, modifying a transmission profile used by the active portion to transmit a first set of downlink signals.

2. The system of claim 1, wherein the operations further comprise not modifying a transmission profile used by the passive portion to transmit a second set of downlink signals.

3. The system of claim 2, wherein modifying the transmission profile comprises communicating the first set of downlink signals using a second frequency band instead of a first frequency band, the second frequency band having a lower center frequency than the first frequency band.

4. The system of claim 3, wherein the trigger event is a greater than threshold downtilt of the antenna assembly by a mechanical downtilting component.

5. The system of claim 3, wherein the trigger event comprises a greater than threshold number of user equipment being located greater than a threshold distance from active passive antenna system.

6. The system of claim 3, wherein the active portion is configured to use a first radio access technology (RAT) and the passive portion is configured to use a second RAT, the first RAT being different than the second RAT.

7. The system of claim 6, wherein the active portion is configured to transmit signals on a first set of one or more frequency bands and the passive portion is configured to transmit signals on a second set of one or more frequency bands, each frequency band of the first set of frequency bands being different than each frequency band of the second set of frequency bands.

8. The system of claim 3, wherein the active portion comprises a plurality of subarrays, each of the plurality of subarrays being configured to transmit the first set of downlink signals using a different set of downlink frequency bands.

9. The system of claim 8, wherein at least one subarray of the plurality of subarrays is configured to transmit the first set of downlink signals using a plurality of frequency bands.

10. The system of claim 9, wherein the passive portion is configured to communicate using only one frequency band.

11. The system of claim 10, wherein the active portion is configured to transmit the first set of downlink signals at a higher frequency than the passive portion is configured to transmit the second set of downlink signals.

12. The system of claim 11, wherein the antenna assembly further comprises a void space.

13. The system of claim 3, wherein each of the active portion and the passive portion are configured to communicate with a user equipment (UE) using Wi-Fi, the passive portion is configured to communicate on a 2.4 GHz frequency band, and the active portion is configured to communicate on at least one frequency band having a center frequency higher than the 2.4 GHz frequency band.

14. The system of claim 3, wherein the trigger event comprises detecting a threshold high noise level at the active portion of the antenna assembly.

15. The system of claim 14, wherein modifying the transmission profile comprises increasing a transmission power used to transmit the first set of downlink signals.

16. A method for operating an active passive antenna system, the method comprising:
transmitting a first set of downlink signals from an active portion of an antenna assembly using a first active transmission profile to a first coverage area;
transmitting a second set of downlink signals from a passive portion of the antenna assembly using a passive transmission profile to a second coverage area;
determining that a trigger event has occurred; and
in response to said determination, transmitting the first set of downlink signals from the active portion of the antenna assembly using a second active transmission profile, the second active transmission profile being different than the first active transmission profile.

17. The method of claim 16, wherein the trigger event comprises a greater than threshold downtilt of the antenna assembly by a mechanical downtilting component, the first active transmission profile comprises using a first frequency band, and the second active transmission profile comprises using a second frequency band, the second frequency band having a center frequency lower than the first frequency band.

18. The method of claim 16, wherein the trigger event comprises a greater than threshold number of user equipment being located greater than a threshold distance from the antenna assembly, the first active transmission profile comprises using a first frequency band, and the second active transmission profile comprises using a second frequency band, the second frequency band having a center frequency lower than the first frequency band.

19. The method of claim 16, wherein the trigger event comprises detecting a threshold high noise level at the active portion of the antenna assembly, the first active transmission profile comprises using a first transmission power, and the second active transmission profile comprises using a second transmission power, the second transmission power being greater than the first transmission power.

20. A non-transitory computer readable media having computer-executable instructions stored thereon that, when executed by one or more computer processor components, cause the one or more computer processing components to perform operations for operating an active passive antenna system, the operations comprising:
transmitting a first set of downlink signals from an active portion of an antenna assembly using a first active transmission profile to a first coverage area;
transmitting a second set of downlink signals from a passive portion of the antenna assembly using a passive transmission profile to a second coverage area;
determining that a trigger event has occurred; and
in response to said determination, transmitting the first set of downlink signals from the active portion of the antenna assembly using a second active transmission profile, the second active transmission profile being different than the first active transmission profile.
